(19) United States
(12) Patent Application Publication
(10) Pub. No.: US 2017/0311329 A1
(43) Pub. Date: Oct. 26, 2017

(54) RECONCILING DIFFERENT SPATIAL REUSE MODES

(71) Applicant: QUALCOMM Incorporated, San Diego, CA (US)

(72) Inventors: Gwendolyn Denise Barriac, Encinitas, CA (US); Yan Zhou, San Diego, CA (US); George Cherian, San Diego, CA (US); Alfred Asterjadhi, San Diego, CA (US); Simone Merlin, San Diego, CA (US)

(21) Appl. No.: 15/495,888

(22) Filed: Apr. 24, 2017

Related U.S. Application Data
(60) Provisional application No. 62/327,273, filed on Apr. 25, 2016.

(51) Int. Cl. H04W 72/04; H04W 72/08

(52) U.S. Cl. CPC H04W 72/0493; H04W 72/082; H04W 72/0446; H04W 72/0453

(57) ABSTRACT

In certain aspects, an apparatus for wireless communication is provided. The apparatus comprises an interface configured to receive a packet transmitted by another apparatus using a resource, and a processing system configured to determine whether to reuse the resource for a transmission by the apparatus based on one or more reuse constraints. The interface is further configured to output another packet for transmission using the resource if a determination is made to reuse the resource.

### RELATED APPLICATION

This application claims priority under 35 U.S.C. §119(e) to U.S. Provisional Application No. 62/327,273 filed on Apr. 25, 2016, the entire specification of which is incorporated herein by reference.

### FIELD

Certain aspects of the present disclosure generally relate to wireless communication and, more particularly, to spatial reuse in wireless communication systems.

### BACKGROUND

A wireless communication system may include an access point (“AP”) and one or more access terminals (“AT”) that transmit data to and receive data from the AP. To increase throughput, a wireless node (e.g., AP or AT) in the wireless communication system may employ spatial reuse, in which the wireless node reuses one or more resources (e.g., frequency bands) used by a neighboring wireless communication system. However, reusing resources may cause excessive interference under certain conditions. Accordingly, the wireless node may determine whether one or more constraints are met before reusing a resource.

### SUMMARY

A first aspect relates to an apparatus for wireless communication. The apparatus comprises an interface configured to receive a packet transmitted by another apparatus using a resource, and a processing system configured to determine whether to reuse the resource for a transmission by the apparatus based on one or more reuse constraints. The interface is further configured to output another packet for transmission using the resource if a determination is made to reuse the resource.

A second aspect relates to a method for wireless communication. The method comprises receiving a packet at an apparatus transmitted by another apparatus using a resource, determining whether to reuse the resource for a transmission by the apparatus based on one or more reuse constraints, and outputting another packet for transmission using the resource if a determination is made to reuse the resource.

A third aspect relates to an apparatus for wireless communication. The apparatus comprises means for receiving a packet at an apparatus transmitted by another apparatus using a resource, means for determining whether to reuse the resource for a transmission by the apparatus based on one or more reuse constraints, and means for outputting another packet for transmission using the resource if a determination is made to reuse the resource.

A fourth aspect relates to a computer readable medium. The computer readable medium comprises instructions stored thereon for receiving a packet at an apparatus from another apparatus transmitted by another apparatus using a resource, determining whether to reuse the resource for a transmission by the apparatus based on one or more reuse constraints, and outputting another packet for transmission using the resource if a determination is made to reuse the resource.

A fifth aspect relates to a wireless node. The wireless node comprises at least one receiver configured to receive a packet transmitted by another wireless node using a resource, a processing system configured to determine whether to reuse the resource for a transmission by the wireless node based on one or more reuse constraints, and at least one transmitter configured to transmit another packet using the resource if a determination is made to reuse the resource.

### BRIEF DESCRIPTION OF THE DRAWINGS

FIG. 1 illustrates an exemplary wireless communication system in accordance with certain aspects of the present disclosure.

FIG. 2 is a block diagram of an exemplary access point and access terminal in accordance with certain aspects of the present disclosure.

FIG. 3 illustrates an example of an overlapping basic service set (OBSS) in accordance with certain aspects of the present disclosure.

FIG. 4 is a flowchart of a method for wireless communication in accordance with certain aspects of the present disclosure.

FIG. 5 illustrates an exemplary device in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple access terminals. A TDMA system may allow multiple access terminals to share the same frequency channel by dividing the transmission signal into different time slots, each time slot being assigned to different access terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a wireless access point (“WAP”), a Radio Network Controller (“RNC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known a station (“STA”), a subscriber station, a subscriber unit, a mobile station, a remote station, a remote terminal, a user terminal, a user agent, a user device, user equipment (“UE”), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

With reference to the following description, it shall be understood that not only communications between access points and access terminals are allowed, but also direct (e.g., peer-to-peer) communications between respective access terminals are allowed. Furthermore, a device (e.g., an access point or access terminal) may change its behavior between an access terminal and an access point according to various conditions.

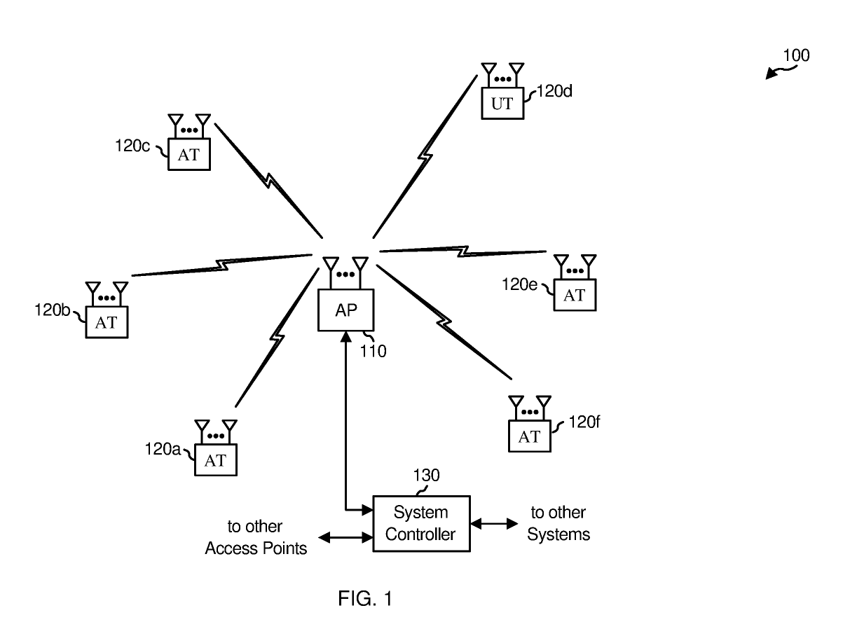

FIG. 1 is a diagram of an exemplary wireless communication system 100 in accordance with certain aspects of the present disclosure. The wireless communication system 100 includes a plurality of wireless nodes, such as access points and access terminals. For simplicity, only one access point 110 is shown. The access point 110 may communicate (e.g., according to an IEEE 802.11 protocol) with one or more access terminals (“ATs”) 120a-120f at any given moment on the downlink and uplink. The downlink (i.e., forward link) is the communication link from the access point 110 to the access terminals 120a-120f, and the uplink (i.e., reverse link) is the communication link from the access terminals 120a-120f to the access point 110. An access terminal may also communicate peer-to-peer with another access terminal. A system controller 130 couples to and provides coordination and control for the access points. The access point 110 may communicate with other devices coupled to a backbone network. The wireless communication system 100 is discussed further below.

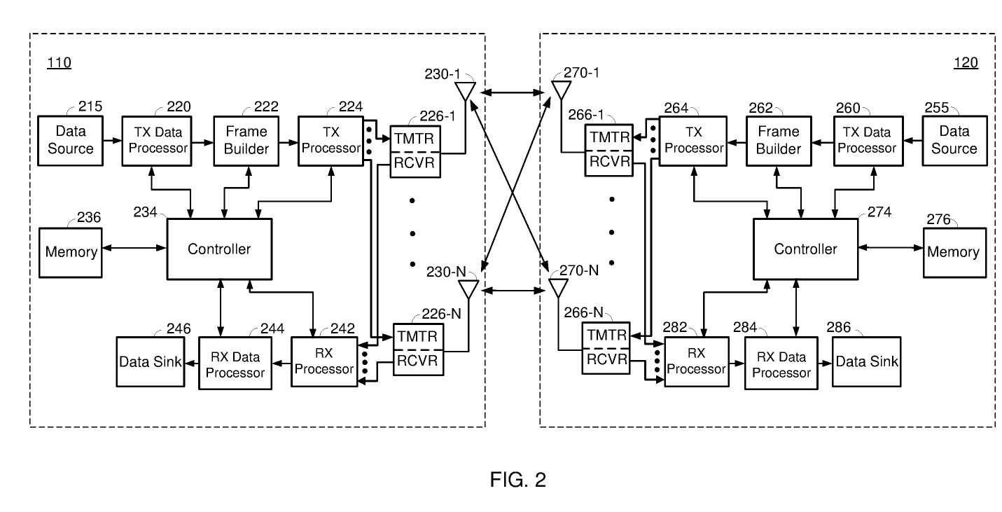

FIG. 2 illustrates a block diagram of an access point 110 (generally, a first wireless node) and an access terminal 120 (generally, a second wireless node) of the wireless communication system 100. The access point 110 is a transmitting entity for the downlink and a receiving entity for the uplink. The access terminal 120 is a transmitting entity for the uplink and a receiving entity for the downlink. As used herein, a “transmitting entity” is an independently operated apparatus or wireless node capable of transmitting data via a wireless channel, and a “receiving entity” is an independently operated apparatus or wireless node capable of receiving data via a wireless channel.

For transmitting data, the access point 110 comprises a transmit data processor 220, a frame builder 222, a transmit processor 224, a plurality of transceivers 226-1 to 226-N, and a plurality of antennas 230-1 to 230-N. The access point 110 also comprises a controller 234 configured to control operations of the access point 110, as discussed further below.

In operation, the transmit data processor 220 receives data (e.g., data bits) from a data source 215, and processes the data for transmission. For example, the transmit data processor 220 may encode the data (e.g., data bits) into encoded data, and modulate the encoded data into data symbols. The transmit data processor 220 may support different modulation and coding schemes (MCSs). For example, the transmit data processor 220 may encode the data at any one of a plurality of different coding rates. Also, the transmit data processor 220 may modulate the encoded data using any one of a plurality of different modulation schemes, including, but not limited to, BPSK, QPSK, 16QAM, 64QAM, 64APSK, 128APSK, 256QAM, and 256APSK.

In certain aspects, the controller 234 may send a command to the transmit data processor 220 specifying which modulation and coding scheme (MCS) to use (e.g., based on channel conditions of the downlink), and the transmit data processor 220 may encode and modulate data from the data source 215 according to the specified MCS. It is to be appreciated that the transmit data processor 220 may perform additional processing on the data such as data scrambling, and/or other processing. The transmit data processor 220 outputs the data symbols to the frame builder 222.

The frame builder 222 constructs a frame (also referred to as a packet), and inserts the data symbols into a data payload of the frame. Exemplary frame structures or formats are discussed further below. The frame builder 222 outputs the frame to the transmit processor 224. The transmit processor 224 processes the frame for transmission on the downlink. For example, the transmit processor 224 may support different transmission modes such as an orthogonal frequency-division multiplexing (OFDM) transmission mode and a single-carrier (SC) transmission mode. In this example, the controller 234 may send a command to the transmit processor 224 specifying which transmission mode to use, and the transmit processor 224 may process the frame for transmission according to the specified transmission mode.

In certain aspects, the transmit processor 224 may support multiple-output-multiple-input (MIMO) transmission. In these aspects, the access point 110 includes multiple antennas 230-1 to 230-N and multiple transceivers 226-1 to 226-N (e.g., one for each antenna). The transmit processor 224 may perform spatial processing on the incoming frames and provide a plurality of transmit streams for the plurality of antennas 230-1 to 230-N. The transceivers 226-1 to 226-N receive and process (e.g., convert to analog, amplify, filter, and frequency upconvert) the respective transmit streams to generate transmit ready signals for transmission via the antennas 230-1 to 230-N.

For transmitting data, the access terminal 120 comprises a transmit data processor 260, a frame builder 262, a transmit processor 264, a plurality of transceivers 266-1 to 266-N, and a plurality of antennas 270-1 to 270-N. The access terminal 120 may transmit data to the access point 110 on the uplink, and/or transmit data to another access terminal (e.g., for peer-to-peer communication). The access terminal 120 also comprises a controller 274 configured to control operations of the access terminal 120, as discussed further below.

In operation, the transmit data processor 260 receives data (e.g., data bits) from a data source 255, and processes (e.g., encodes and modulates) the data for transmission. The transmit data processor 260 may support different MCSs. For example, the transmit data processor 260 may encode the data at any one of a plurality of different coding rates, and modulate the encoded data using any one of a plurality of different modulation schemes, including, but not limited to, BPSK, QPSK, 16QAM, 64QAM, 64APSK, 128APSK, 256QAM, and 256APSK. In certain aspects, the controller 274 may send a command to the transmit data processor 260 specifying which MCS to use (e.g., based on channel conditions of the uplink), and the transmit data processor 260 may encode and modulate data from the data source 255 according to the specified MCS. It is to be appreciated that the transmit data processor 260 may perform additional processing on the data. The transmit data processor 260 outputs the data symbols to the frame builder 262.

The frame builder 262 constructs a frame, and inserts the received data symbols into a data payload of the frame. Exemplary frame structures or formats are discussed further below. The frame builder 262 outputs the frame to the transmit processor 264. The transmit processor 264 processes the frame for transmission. For example, the transmit processor 264 may support different transmission modes such as an OFDM transmission mode and an SC transmission mode. In this example, the controller 274 may send a command to the transmit processor 264 specifying which transmission mode to use, and the transmit processor 264 may process the frame for transmission according to the specified transmission mode.

In certain aspects, the transmit processor 264 may support multiple-output-multiple-input (MIMO) transmission. In these aspects, the access terminal 120 includes multiple antennas 270-1 to 270-N and multiple transceivers 266-1 to 266-N (e.g., one for each antenna). The transmit processor 264 may perform spatial processing on the incoming frame and provide a plurality of transmit streams for the plurality of antennas 270-1 to 270-N. The transceivers 266-1 to 266-N receive and process (e.g., convert to analog, amplify, filter, and frequency upconvert) the respective transmit streams to generate transmit ready signals for transmission via the antennas 270-1 to 270-N.

For receiving data, the access point 110 comprises a receive processor 242, and a receive data processor 244. In operation, the transceivers 226-1 to 226-N receive signals (e.g., from the access terminal 120) via the antennas 230-1 to 230-N, and process (e.g., frequency downconvert, amplify, filter and convert to digital) the received signals.

The receive processor 242 receives the outputs of the transceivers 226-1 to 226-N, and processes the outputs to recover data symbols. For example, the access point 110 may receive data (e.g., from the access terminal 120) in a frame. In this example, the receive processor 242 may detect the start of the frame using a short training field (“STF”) sequence in the preamble of the frame. The receive processor 242 may also perform channel estimation (e.g., using the channel estimation sequence in the preamble of the frame) and perform channel equalization on the received signal based on the channel estimation.

The receive processor 242 may also recover information (e.g., MCS scheme) from the header of the frame, and send the information to the controller 234. After performing channel equalization, the receive processor 242 may recover data symbols from the frame, and output the recovered data symbols to the receive data processor 244 for further processing. It is to be appreciated that the receive processor 242 may perform other processing.

The receive data processor 244 receives the data symbols from the receive processor 242 and an indication of the corresponding MSC scheme from the controller 234. The receive data processor 244 demodulates and decodes the data symbols to recover the data according to the indicated MSC scheme, and outputs the recovered data (e.g., data bits) to a data sink 246 for storage and/or further processing.

As discussed above, the access terminal 120 may transmit data using an OFDM transmission mode or a SC transmission mode. In this case, the receive processor 242 may process the receive signal according to the selected transmission mode. Also, as discussed above, the transmit processor 264 may support multiple-output-multiple-input (MIMO) transmission. In this case, the access point 110 includes multiple antennas 230-1 to 230-N and multiple transceivers 226-1 to 226-N (e.g., one for each antenna). Each transceiver receives and processes (e.g., frequency downconverts, amplifies, filters, frequency upconverts) the signal from the respective antenna. The receive processor 242 may perform spatial processing on the outputs of the transceivers 226-1 to 226-N to recover the data symbols.

For receiving data, the access terminal 120 comprises a receive processor 282, and a receive data processor 284. In operation, the transceivers 266-1 to 266-N receive signals (e.g., from the access point 110 or another access terminal) via the antennas 270-1 to 270-N, and process (e.g., frequency downconvert, amplify, filter and convert to digital) the received signals.

The receive processor 282 receives the output of the transceivers 266-1 to 266-N, and processes the output to recover data symbols. For example, the access terminal 120 may receive data (e.g., from the access point 110 or another access terminal) in a frame, as discussed above. In this example, the receive processor 282 may detect the start of the frame using the STF sequence in the preamble of the frame. The receive processor 282 may also perform channel estimation (e.g., using the channel estimation sequence in the preamble of the frame) and perform channel equalization on the received signal based on the channel estimation.

The receive processor 282 may also recover information (e.g., MCS scheme) from the header of the frame, and send the information to the controller 274. After performing channel equalization, the receive processor 282 may recover data symbols from the frame, and output the recovered data symbols to the receive data processor 284 for further processing. It is to be appreciated that the receive processor 282 may perform other processing.

The receive data processor 284 receives the data symbols from the receive processor 282 and an indication of the corresponding MSC scheme from the controller 274. The receive data processor 284 demodulates and decodes the data symbols to recover the data according to the indicated MSC scheme, and outputs the recovered data (e.g., data bits) to a data sink 286 for storage and/or further processing.

As discussed above, the access terminal 120 or another access terminal may transmit data using an OFDM transmission mode or a SC transmission mode. In this case, the receive processor 282 may process the receive signal according to the selected transmission mode. Also, as discussed above, the transmit processor 224 may support multiple-output-multiple-input (MIMO) transmission. In this case, the access terminal 120 includes multiple antennas 270-1 to 270-N and multiple transceivers 266-1 to 266-N (e.g., one for each antenna). Each transceiver receives and processes (e.g., frequency downconverts, amplifies, filters and converts to digital) the signal from the respective antenna. The receive processor 282 may perform spatial processing on the outputs of the transceivers to recover the data symbols.

As shown in FIG. 2, the access point 110 also comprises a memory 236 coupled to the controller 234. The memory 236 may store instructions that, when executed by the controller 234, cause the controller 234 to perform one or more of the operations described herein. Similarly, the access terminal 120 also comprises a memory 276 coupled to the controller 274. The memory 276 may store instructions that, when executed by the controller 274, cause the controller 274 to perform the one or more of the operations described herein.

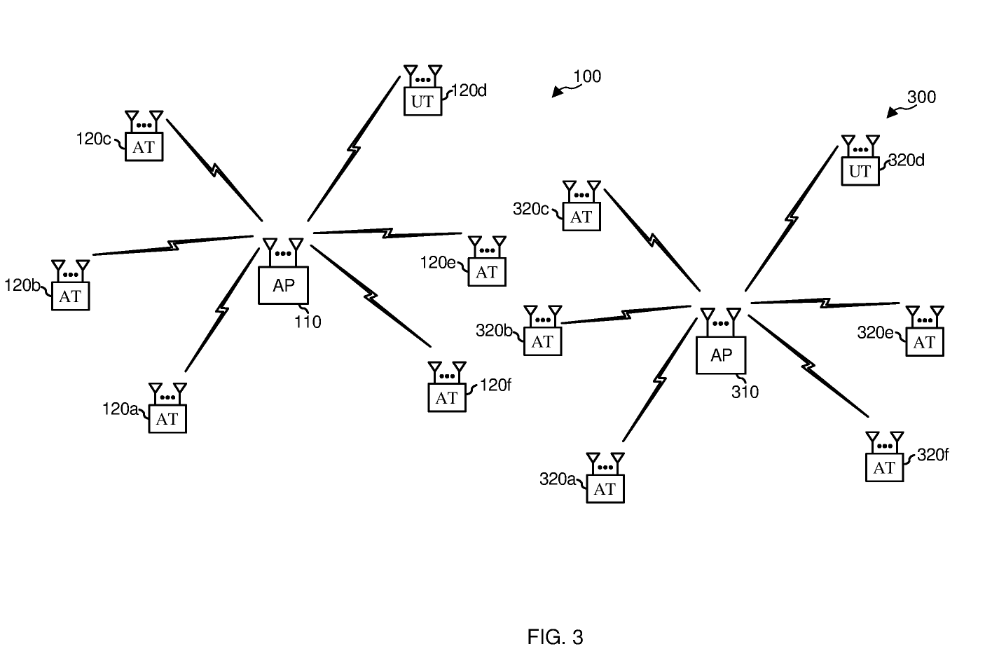

FIG. 3 shows an example in which the coverage area of the wireless communication system 100 overlaps the coverage area of a neighboring wireless communication system 300 (e.g., in a dense environment). The neighboring wireless communication system 300 includes an AP 310 and one or more ATs 320a-320f that communicate with the AP 310. Each AP 110 or 310 or corresponding wireless communication system 100 or 300 may be referred to as a basic service set (“BSS”). The neighboring communication system 300 may be referred to as an overlapping basic service set (“OBSS”) since its coverage area overlaps the coverage area of the wireless communication system 100.

To increase throughput, a wireless node (e.g., AP 110 or AT 120) in the wireless communication system 100 may employ spatial reuse, in which the wireless node reuses one or more resources used by the neighboring wireless communication system 300 (OBSS) for communication. The one or more resources may include one or more frequency bands, channels, carriers, time slots, etc. However, reusing resources may cause excessive interference between the wireless communication systems 100 and 300 under certain conditions. Accordingly, the wireless node (e.g., AP 110 or AT 120) may determine whether one or more constraints are met before reusing a resource, as discussed further below.

A wireless node (e.g., AP 110 or AT 120) may receive a packet from a wireless node (e.g., AP 310 or AT 320) in the neighboring wireless communication system 300 (OBSS). The packet may be addressed to another wireless node in the neighboring wireless communication system 300. The packet may include an identifier identifying the BSS of the packet. For example, the packet may include the identifier in a field (e.g., color field) in the preamble (e.g., at the physical layer) or header of the packet (e.g., at the MAC layer). The wireless node (e.g., AP 110 or AT 120) may decode the identifier to identify the BSS of the packet, and determine that the packet is an OBSS packet since the identified BSS is different from the BSS of the wireless node. The packet may also include length information specifying the length (duration) of the packet. The wireless node (e.g., AP 110 or AT 120) may decode this information to determine the duration of the packet.

The wireless node (e.g., AP 110 or AT 120) may then determine whether to reuse the same resource (e.g., frequency band) used to transmit the OBSS packet. For example, the wireless node may determine whether to reuse the same resource for a transmission by the wireless node within the duration of the OBSS packet (i.e., transmit on top of the OBSS packet). This determination may involve determining whether one or more reuse constraints are met. Examples of reuse constraints are discussed below.

One constraint is that a received signal strength of the OBSS packet be equal to or below a certain threshold. In this regard, the wireless node (e.g., AP 110 or AT 120) may measure the signal strength of the received OBSS packet to obtain the received signal strength (e.g., received signal strength indicator (RSSI)). The threshold may be an OBSS_PD level set by one or more rules according to the IEEE 802.11ax standard and/or another standard. The OBSS_PD level may be a function of the transmit power at which the wireless node wants to transmit. Decreasing the transmit power may increase the OBSS_PD level, and vice versa.

A second constraint is specified by spatial reuse parameters in the OBSS packet. For example, the spatial reuse parameters may be in a field (e.g., SIGA field) in the preamble (e.g., at the physical layer) or header of the OBSS packet (e.g., at the MAC layer). The spatial reuse parameters may include one or more of the following:
1. Reuse indicator,
2. Allowed interference level, and
3. Transmit Power.
   The above parameters are discussed further below. It is to be appreciated that the present disclosure is not limited to the exemplary parameters given above.

The reuse indicator indicates whether reuse is permitted during the duration of the OBSS packet. The reuse indicator may include a bit, in which the value of the bit indicates whether reuse is permitted. If the reuse indicator indicates that reuse is not permitted, then the wireless node (e.g., AP 110 or AT 120) may refrain from reusing the same resource during the duration of the packet (e.g., refrain from transmitting on top of the OBSS). If the reuse indicator indicates that reuse is permitted, then the wireless node may reuse the same resource or check one or more other spatial reuse parameters before making a decision whether to reuse the same resource.

The allowed interference level may be an interference level allowed by the neighboring wireless node transmitting the OBSS packet. In this regard, the wireless node (e.g., AP 110 or AT 120) may determine the interface level that a transmission by the wireless node using the same resource would cause at the neighboring wireless node, or at the intended receiver of the neighboring wireless node, and determine whether the determined interference level is equal to or below the allowed interference level. If the determined interference level is above the allowed interference level, then the wireless node (e.g., AP 110 or AT 120) may refrain from reusing the same resource during the duration of the packet (e.g., refrain from transmitting on top of the OBSS). If the determined interference level is equal to or below the allowed interference level, then the wireless node may reuse the same resource or check one or more other spatial reuse parameters before making a decision whether to reuse the same resource.

The wireless node (e.g., AP 110 or AT 120) may determine the interference level using any one of a variety of techniques. For example, the wireless node may determine a path loss between the nodes based on the transmit power at the neighboring wireless node and the received power of the OBSS packet at the wireless node. The transmit power at the neighboring wireless node may be included in the spatial reuse parameters and the received power of the OBSS packet may be measured by the wireless node. After determining the path loss, the wireless node may determine the interference level based on the path loss and the power at which the wireless wants to transmit.

The wireless node determines whether the second constraint is met based on the spatial reuse parameters included in the packet (e.g., in the SIGA field of the packet). For example, if the spatial reuse parameters include the reuse indicator, then the wireless node may determine the second constraint is not met if the reuse indicator indicates that reuse is not permitted. If the spatial reuse parameters include the reuse indicator and the allowed interference level, then the wireless node may first determine whether the reuse indicator indicates that reuse is permitted. If the reuse indicator indicates that reuse is permitted, then the wireless node may determine whether the determined interference level is equal to or below the allowed interference level. If determined interference is equal to or below the allowed interference level, then the wireless node may determine that the second constraint is met. If the determined interference is above the allowed interference level, then the wireless node may determine that the second constraint is not met. If the spatial reuse parameters include the allowed interference level but not the reuse indicator, then the wireless node may determine whether the second constraint is met based on whether the determined interference level is equal to or below the allowed interference level, as discussed above.

Thus, the first constraint is that the received signal strength (e.g., RSSI) of the OBSS packet be equal to or below a threshold (e.g., OBSS_PD level), and the second constraint, or set of constraints, is specified by spatial reuse parameters in the OBSS packet (e.g., in the SIGA field of the OBSS packet). However, it is not clear whether both constraints have to be met or only one of the constraints has to be met to reuse the same resource as the OBSS packet. Further complicating matters, it is not clear what to do in cases where one of the constraints is met and the other constraint is not.

Embodiments of the present disclosure provide methods for determining whether to reuse the same resource as the OBSS packet when one or both constraints are present, as discussed further below.

In a first embodiment, the wireless node (e.g., AP 110 or AT 120) determines to reuse the same resource as the OBSS packet if both constraints are met. In this embodiment, the wireless node may determine whether the first constraint is met (i.e., whether the received signal strength (e.g., RSSI) of the OBSS packet is equal to or below a threshold (e.g., OBSS_PD level)), and whether the second constraint specified by the spatial reuse parameters in the OBSS packet is met. If both constraints are met, then the wireless node may make a determination to reuse the same resource as the OBSS packet (e.g., transmit on top of the OBSS packet, or resume its backoff while the OBSS packet is in transmission). If one or both of the constraints are not met, then the wireless node refrains from using the same resource as the OBSS packet (e.g., for at least the duration of the OBSS packet, or for the duration set by the NAV of the OBSS packet). In this case, the wireless node may use another resource for transmission and/or wait until the OBSS packet is finished transmitting (or the NAV set by the OBSS packet expires). This embodiment is a conservative approach for interference mitigation since it looks at whether both constraints are met.

In the first embodiment, the wireless node may first check whether the first constraint is met. If the first constraint is not met, then the wireless node may determine not to reuse the same resource as the OBSS. In this case, the wireless node may not bother with checking the second constraint since it is already known that both constraints will not be met. If the first constraint is met, then the wireless may check whether the second constraint is met.

Alternatively, in the first embodiment, the wireless node may first check whether the second constraint is met. If the second constraint is not met, then the wireless node may determine not to reuse the same resource as the OBSS. In this case, the wireless node may not bother with checking the first constraint since it is already known that both constraints will not be met. If the second constraint is met, then the wireless may check whether the first constraint is met.

In a second embodiment, the wireless node (e.g., AP 110 or AT 120) determines to reuse the same resource as the OBSS packet if either one of the constraints is met. In this embodiment, the wireless node may determine whether the first constraint is met and/or whether the second constraint is met. If at least one of the constraints is met, then the wireless node makes a determination to reuse the same resource as the OBSS packet (e.g., transmit on top of the OBSS packet). If neither constraint is met, then the wireless node refrains from using the same resource as the OBSS packet (e.g., for at least the duration of the OBSS packet). This approach may provide greater throughput since it only requires that one of the constraints be met for reuse.

In the second embodiment, the wireless node may first check whether the first constraint is met. If the first constraint is met, then the wireless node may determine to reuse the same resource as the OBSS packet. In this case, the wireless node may not bother with checking the second constraint since it is already known that at least one of the constraints is met. If the first constraint is not met, then the wireless may check whether the second constraint is met.

Alternatively, in the second embodiment, the wireless node may first check whether the second constraint is met. If the second constraint is met, then the wireless node may determine to reuse the same resource as the OBSS packet. In this case, the wireless node may not bother with checking the first constraint since it is already known that at least one of the constraints is met. If the second constraint is not met, then the wireless may check whether the first constraint is met.

In a third embodiment, the wireless node (e.g., AP 110 or AT 120) only checks the second constraint and determines to reuse the same resource as the OBSS packet if the second constraint is met. In this embodiment, the wireless node may determine whether the second constraint specified by the spatial reuse parameters in the OBSS packet is met. If second constraint is met, then the wireless node may make a determination to reuse the same resource as the OBSS packet (e.g., transmit on top of the OBSS packet). If the second constraint is not met, then the wireless node refrains from using the same resource as the OBSS packet (e.g., for at least the duration of the OBSS packet) without checking the first constraint. In this embodiment, the second constraint trumps the first constraint.

In a fourth embodiment, the wireless node (e.g., AP 110 or AT 120) only checks the first constraint and determines to reuse the same resource as the OBSS packet if the first constraint is met. In this embodiment, the wireless node may determine whether the first constraint is met (i.e., whether the received signal strength (e.g., RSSI) of the OBSS packet is equal to or below a threshold (e.g., OBSS_PD level)). If first constraint is met, then the wireless node may make a determination to reuse the same resource as the OBSS packet (e.g., transmit on top of the OBSS packet). If the first constraint is not met, then the wireless node refrains from using the same resource as the OBSS packet (e.g., for at least the duration of the OBSS packet) without checking the second constraint. In this embodiment, the first constraint trumps the second constraint.

In a fifth embodiment, the wireless node (e.g., AP 110 or AT 120) may check whether the OBSS packet includes the spatial reuse parameters. If the OBSS packet includes the spatial reuse parameters, then the wireless node may determine whether to reuse the same resource as the OBSS according to the first embodiment, the second embodiment or the third embodiment.

If the OBSS packet does not include the spatial reuse parameters (e.g., the OBSS packet is legacy packet), then there are two options. In one option, the wireless node determines not to reuse at all. In the second option, the wireless node may determine whether the first constraint is met (i.e., whether the received signal strength (e.g., RSSI) of the OBSS packet is equal to or below a threshold (e.g., OBSS_PD level)). If first constraint is met, then the wireless node may make a determination to reuse the same resource as the OBSS packet (e.g., transmit on top of the OBSS packet). If the first constraint is not met, then the wireless node refrains from using the same resource as the OBSS packet (e.g., for at least the duration of the OBSS packet). The wireless node may also determine whether to reuse based on the type of PHY preamble (non HT, VHT, HE, etc.). For example, the wireless node may only choose to reuse on packets that meet the first constraint and are of a specific PHY type.

In a sixth embodiment, the wireless node (e.g., AP 110 or AT 120) may check whether the OBSS packet includes the reuse indicator. If the OBSS packet does not include a reuse indicator, then the wireless node may determine whether to reuse the same resource as the OBSS packet according to the first embodiment, the second embodiment or the third embodiment.

In one embodiment, if the OBSS packet includes the reuse indicator, then the wireless node determines whether the reuse indicator indicates that reuse is permitted. If the reuse indicator indicates that reuse is not permitted, then the wireless node may refrain from using the same resource as the OBSS packet (e.g., for at least the duration of the OBSS packet). If the reuse indicator indicates that reuse is permitted, then the wireless node may make a determination to reuse if either one of the constraints is met. Thus, in this embodiment, an indication that reuse is not permitted by the reuse indicator is controlling. In this case, the wireless node determines not to reuse. If, on the other hand, the reuse indicator indicates that reuse is permitted, then the wireless node may determine to reuse if either of the constraints is met (if both constraints are met, if the first constraint is met, or if the second constraint is met). The reuse indicator may be considered as a constraint in constraint set 2.

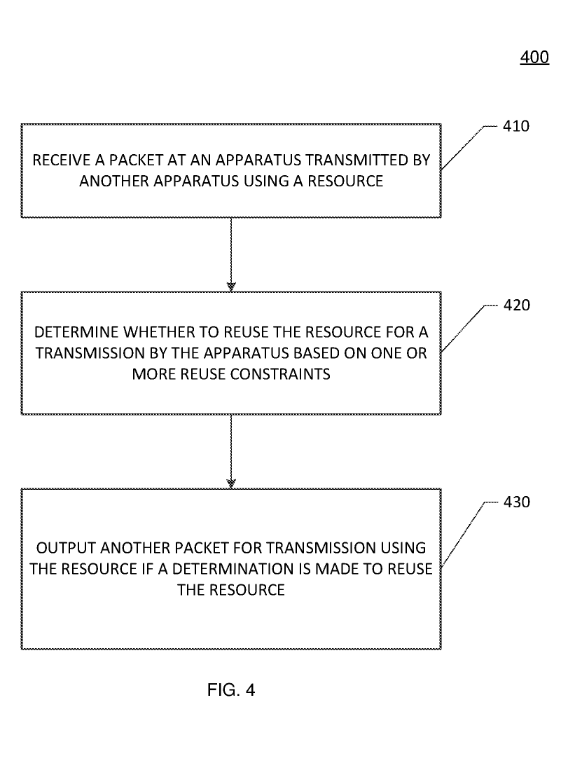

FIG. 4 is a flowchart illustrating a method 400 for wireless communication according to certain aspects of the present disclosure. The method 400 may be performed by a wireless node (e.g., AP 110 or AT 120).

At step 410, a packet is received at an apparatus transmitted by another apparatus using a resource. For example, the packet may be an OBSS packet (e.g., a packet identifying a BSS that is different from the BSS of the apparatus). The resource may include at least one of a frequency band, a channel, a carrier, or a time slot.

At step 420, a determination is made whether to reuse the resource for a transmission by the apparatus based on one or more reuse constraints. The one or more constraints may include a first constraint that a received signal strength (e.g., RSSI) of the packet be equal to or below a threshold (e.g., OBSS_PD level), and a second constraint specified by one or more spatial reuse parameters in the packet (e.g., in a SIGA field in the preamble of the packet).

At step 430, another packet is output for transmission using the resource if a determination is made to reuse the resource. For example, the other packet may be transmitted on top of the packet (e.g., OBSS packet).

In one example, the determination whether to reuse the resource at step 420 may comprise determining to reuse the resource only if both the first and second constraints are met. In another example, the determination whether to reuse the resource at step 420 may comprise determining to reuse the resource if either one of the first and second constraints is met. In yet another example, only the second constraint may be checked, and the determination whether to reuse the resource at step 420 may comprise determining to reuse the resource if the second constraint is met. In still another example, only the first constraint may be checked, and the determination whether to reuse the resource at step 420 may comprise determining to reuse the resource if the first constraint is met. It is to be appreciated that step 420 is not limited to the above examples.

In certain aspects, the first constraint may be met when the receive signal strength is equal or lower than the threshold (e.g., OBSS PD level), which may be set as a function of the transmit power. In any case, the first constraint is not met when the receive signal strength is above the threshold. Also, the second constraint may be met when the determined interference level is equal to the allowed interference level. In any case, when the spatial reuse parameters include an allowed interference level, the second constraint is not met when the determined interference level is above the allowed interference level

In this disclosure, it is to be appreciated that the second constraint may be made up of a set of constraints specified by the spatial reuse parameters, and that the second constraint may be met when the set of constraints are met and not met when the set of constraints are not met.

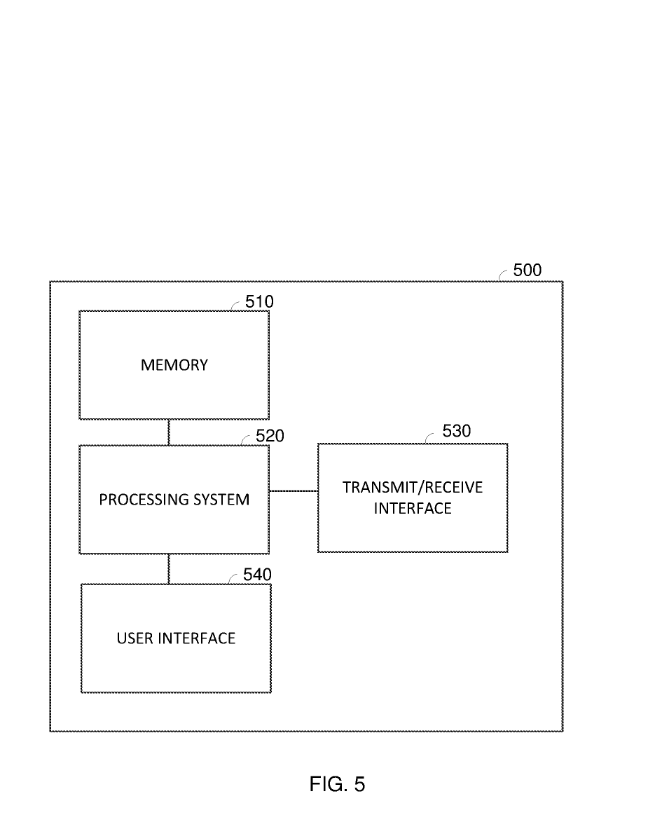

FIG. 5 illustrates an example device 500 according to certain aspects of the present disclosure. The device 500 may be configured to operate in a wireless node (e.g., access point 110 or access terminal 120) and to perform one or more of the operations described herein. The device 500 includes a processing system 520, and a memory 510 coupled to the processing system 520. The memory 510 may store instructions that, when executed by the processing system 520, cause the processing system 520 to perform one or more of the operations described herein. Exemplary implementations of the processing system 520 are provided below. The device 500 also comprises a transmit/receive interface 530 coupled to the processing system 520. The interface 530 (e.g., interface bus) may be configured to interface the processing system 520 to a radio frequency (RF) front end (e.g., transceivers 226-1 to 226-N or 226-1 to 266-N).

In certain aspects, the processing system 520 may include one or more of the following: a transmit data processor (e.g., transmit data processor 220 or 260), a frame builder (e.g., frame builder 222 or 262), a transmit processor (e.g., transmit processor 224 or 264) and/or a controller (e.g., controller 234 or 274) for performing one or more of the operations described herein.

In the case of an access terminal 120, the device 500 may include a user interface 540 coupled to the processing system 520. The user interface 540 may be configured to receive data from a user (e.g., via keypad, mouse, joystick, etc.) and provide the data to the processing system 520. The user interface 540 may also be configured to output data from the processing system 520 to the user (e.g., via a display, speaker, etc.). In this case, the data may undergo additional processing before being output to the user. In the case of an access point 110, the user interface 540 may be omitted.

Examples of means for receiving a packet at an apparatus transmitted by another apparatus using a resource may include at least one of the transceivers 226-1 to 226-M or 266-1 to 266-N, the receive processor 242 or 282, or the transmit/receive interface 530. Examples of means for determining whether to reuse the resource for a transmission by the apparatus based on one or more reuse constraints may include at least one of the controller 234 or 274, or the processing system 520. Examples of means for outputting another packet for transmission using the resource if a determination is made to reuse the resource may include at least one of the transceivers 226-1 to 226-M or 266-1 to 266-N, the transmit processor 224 or 264, or the transmit/receive interface 530. Examples of means for determining whether the first constraint and the second constraint are met may include at least one of the controller 234 or 274, or the processing system 520. Examples of means for determining to reuse the resource if both the first constraint and the second constraint are met may include at least one of the controller 234 or 274, or the processing system 520. Examples of means for determining to refrain from reusing the resource for at least a duration of the packet if at least one of the first constraint or the second constraint is not met may include at least one of the controller 234 or 274, or the processing system 520. Examples of means for measuring a received signal strength of the packet may include at least one of the receive processor 242 or 282, or the transmit/receive interface 530. Examples of means for determining whether the measured received signal strength is equal to or below a threshold may include at least one of the controller 234 or 274, or the processing system 520. Examples of means for determining an interference level that would be caused by a transmission from the apparatus using the resource may include at least one of the controller 234 or 274, or the processing system 520. Examples of means for determining whether the determined interference level is equal to or below the allowed interference level may include at least one of the controller 234 or 274, or the processing system 520. Examples of means for determining whether at least one of the first constraint or the second constraint is met may include at least one of the controller 234 or 274, or the processing system 520. Examples of means for determining to reuse the resource if at least one of the first constraint or the second constraint is met may include at least one of the controller 234 or 274, or the processing system 520. Examples of means for determining to refrain from reusing the resource for at least a duration of the packet if none of the first constraint and the second constraint is met may include at least one of the controller 234 or 274, or the processing system 520. Examples of means for determining to reuse the resource if the measured received signal strength is equal to or below the threshold may include at least one of the controller 234 or 274, or the processing system 520. Examples of means for determining to refrain from reusing the resource for at least a duration of the packet if the measured received signal strength is above the threshold may include at least one of the controller 234 or 274, or the processing system 520. Examples of means for determining whether the constraint specified by the one or more spatial reuse parameters is met may include at least one of the controller 234 or 274, or the processing system 520. Examples of means for determining to reuse the resource if the constraint specified by the one or more spatial reuse parameters is met may include at least one of the controller 234 or 274, or the processing system 520. Examples of means for determining to refrain from reusing the resource for at least a duration of the packet if the constraint specified by the one or more spatial reuse parameters is not met may include at least one of the controller 234 or 274, or the processing system 520.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of an access terminal 120 (see FIG. 2), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by an access terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that an access terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
an interface configured to receive a packet transmitted by another apparatus using a resource; and
a processing system configured to determine whether to reuse the resource for a transmission by the apparatus based on one or more reuse constraints;
wherein the interface is further configured to output another packet for transmission using the resource if a determination is made to reuse the resource.

2. The apparatus of claim 1, wherein the resource includes at least one of a frequency band, a channel, a carrier, or a time slot.

3. The apparatus of claim 1, wherein the packet is an overlapping basic service set (OBSS) packet.

4. The apparatus of claim 1, wherein the one or more constraints comprise a first constraint and a second constraint.

5. The apparatus of claim 4, wherein the determination of whether to reuse comprises:
determine whether the first constraint and the second constraint are met;
determine to reuse the resource if both the first constraint and the second constraint are met; and
determine to refrain from reusing the resource for at least a duration of the packet if at least one of the first constraint or the second constraint is not met.

6. The apparatus of claim 5, wherein the processing system is configured to determine whether the first constraint is met by:
measuring a received signal strength of the packet; and
determining whether the measured received signal strength is equal to or below a threshold.

7. The apparatus of claim 6, wherein the threshold comprises an OBSS_PD level.

8. The apparatus of claim 6, wherein the threshold is a function of a transmit power of the apparatus.

9. The apparatus of claim 5, wherein the packet includes an allowed interference level, and the processing system is configured to determine whether the second constraint is met by:
determining an interference level that would be caused by a transmission from the apparatus using the resource; and
determining whether the determined interference level is equal to or below the allowed interference level.

10. The apparatus of claim 4, wherein the determination of whether to reuse comprises:
determine whether at least one of the first constraint or the second constraint is met;
determine to reuse the resource if at least one of the first constraint or the second constraint is met; and
determine to refrain from reusing the resource for at least a duration of the packet if none of the first constraint and the second constraint is met.

11. The apparatus of claim 1, wherein the one or more constraints comprise a constraint that a received signal strength of the packet be equal to or below a threshold, and the determination of whether to reuse comprises:
measure the received signal strength of the packet;
determine to reuse the resource if the measured received signal strength is equal to or below the threshold; and
determine to refrain from reusing the resource for at least a duration of the packet if the measured received signal strength is above the threshold.

12. The apparatus of claim 11, wherein the threshold comprises an OBSS_PD level.

13. The apparatus of claim 11, wherein the threshold is a function of a transmit power of the apparatus.

14. The apparatus of claim 1, wherein the one or more constraints comprise a constraint specified by one or more spatial reuse parameters in the packet, and the determination of whether to reuse comprises:
determine whether the constraint specified by the one or more spatial reuse parameters is met;
determine to reuse the resource if the constraint specified by the one or more spatial reuse parameters is met; and
determine to refrain from reusing the resource for at least a duration of the packet if the constraint specified by the one or more spatial reuse parameters is not met.

15. The apparatus of claim 14, wherein the spatial reuse parameters comprise an allowed interference level, and the processing system is configured to determine whether the constraint specified by the one or more spatial reuse parameters is met by:
determining an interference level that would be caused by a transmission from the apparatus using the resource; and
determining whether the determined interference level is equal to or below the allowed interference level.

16. A method for wireless communication, comprising:
receiving a packet at an apparatus transmitted by another apparatus using a resource;
determining whether to reuse the resource for a transmission by the apparatus based on one or more reuse constraints; and
outputting another packet for transmission using the resource if a determination is made to reuse the resource.

17. (canceled)

18. (canceled)

19. The method of claim 16, wherein the one or more constraints comprise a first constraint and a second constraint.

20. The method of claim 19, wherein determining whether to reuse the resources comprises:
determining whether the first constraint and the second constraint are met;
determining to reuse the resource if both the first constraint and the second constraint are met; and
determining to refrain from reusing the resource for at least a duration of the packet if at least one of the first constraint or the second constraint is not met.

21.-24. (canceled)

25. The method of claim 19, wherein determining whether to reuse the resources comprises:
determining whether at least one of the first constraint or the second constraint is met;
determining to reuse the resource if at least one of the first constraint or the second constraint is met; and
determining to refrain from reusing the resource for at least a duration of the packet if none of the first constraint and the second constraint is met.

26.-46. (canceled)

47. A wireless node, comprising:
at least one receiver configured to receive a packet transmitted by another wireless node using a resource;
a processing system configured to determine whether to reuse the resource for a transmission by the wireless node based on one or more reuse constraints; and
at least one transmitter configured to transmit another packet using the resource if a determination is made to reuse the resource.
